(19) United States
(12) Patent Application Publication
(10) Pub. No.: US 2007/0167889 A1
(43) Pub. Date: Jul. 19, 2007

(54) Apparatus for performing a finger-pressure treatment

(76) Inventor: Kwang Soo Kim, Seoul (KR)

Correspondence Address: IPLA P.A., 3580 WILSHIRE BLVD., 17TH FLOOR, LOS ANGELES, CA, 90010, US

(21) Appl. No.: 10/598,294

(22) PCT Filed: Mar. 4, 2005
(86) PCT No.: PCT/KR05/00619

§ 371 Date: Aug. 23, 2006

(30) Foreign Application Priority Data
Mar. 5, 2004 (KR) 10-2004-0014961
Aug. 26, 2004 (KR) 10-2004-0067516
Jan. 27, 2005 (KR) 10-2005-0007573

(51) Int. Cl. A61H 7/00

(52) U.S. Cl. 601/134; 601/84; 601/112

(57) ABSTRACT

An apparatus for performing a finger-pressure treatment on a body part includes a first finger-pressure rod to be in contact with one surface of the body part; a second finger-pressure rod for applying press on an opposite surface of the body part substantially opposite to said one surface; a driving unit for generating a rotational force; a rotation axle connected to an end portion of the second finger-pressure rod, for transmitting the rotational force of the driving unit to the second finger-pressure rod; an elastic member which is connected to an end portion of the first finger-pressure rod and applies an elastic force to the first finger-pressure rod in such manner that the first finger-pressure rod is rotated in a first direction opposite to a second direction in which the press of the second finger-pressure rod applied on the body part; and a mounting plate on which the rotation axle is rotatably mounted and the elastic member is mounted. The rotation axle is rotatably inserted into the end portion of the first finger-pressure rod, so that the rotational force of the driving unit is prevented from being transmitted to the first finger-pressure rod.

### TECHNICAL FIELD

The present invention relates to an apparatus for performing a finger-pressure treatment; and, more particularly, to an apparatus for performing a finger-pressure treatment having such an excellent finger-pressure treatment effect as a human finger-pressure treatment effect obtained by pressurizing a body part with an operation using human fingers.

### BACKGROUND ART

Generally, an apparatus for performing a finger-pressure treatment performs a finger-pressure treatment on a specific body part, e.g., a nape of a neck, a waist, arms, legs or the like, by using a vibrating finger-pressure portion having therein a vibration motor.

Hereinafter, a conventional apparatus for performing a finger-pressure treatment on a desired body part with a vibration motor will be described with reference to the accompanying drawing.

FIG. 1 is a cross-sectional view showing a conventional apparatus for performing a finger-pressure treatment, which corresponds to “Apparatus for performing a finger-pressure treatment” disclosed in Utility Model Registration Application No. 2001-73885 filed with the Office of Patent Administration of Korea. As illustrated in FIG. 1, in the conventional apparatus for performing a finger-pressure treatment, a handle grip (not shown) is provided at a lower portion of a casing 1, and electricity feeding lines 3 and 3′ connected to an end portion thereof are installed inside the handle grip. Further, supporting axles 5 and 5′ are installed at both end portions 4 and 4′ of the casing 1 so that the electricity feeding lines 3 and 3′ can be connected thereto. Furthermore, an egg-shaped elliptic object 7 having protruded finger-pressure protuberances 6 are installed between the supporting axles 5 and 5′ by bearings 8 and 8′ and contact rings 9 and 9′ inserted into its both end portions, so that a DC vibration motor 10 installed therein is connected to the contact rings 9 and 9′ by electric wires 11 and 11′.

When such conventional finger-pressure apparatus is used, a power is supplied by operating a switch (not shown) attached to the handle grip (not shown) to the DC vibration motor 10 through the electricity feeding lines 3 and 3′ via the supporting axles 5 and 5′, the bearings 8 and 8′ and the contact rings 9 and 9′, thereby vibrating the elliptic object 7.

In such state, if the elliptic object 7 is brought in contact with a body part to be massaged, the finger-pressure protuberances 6 protruded from the elliptic object 7 in vibration perform a finger-pressure treatment while vibrating the body part.

### DISCLOSURE OF INVENTION

### Technical Problem

Since, however, finger-pressure apparatuses using a vibration from the vibration motor, including the aforementioned conventional finger-pressure apparatus, just apply vibration on the body part with the finger-pressure protuberances 6 being incapable of pressing the body part as if human fingers do, the finger pressure treatment is not effectively performed by these finger-pressure apparatus.

Moreover, in order to efficiently transmit the vibration of the finger-pressure protuberances 6 to the body part, the finger-pressure protuberances 6 need to be pressed to that body part with a considerable force and, thus, it is inconvenient and arduous for the user to use it for a long period of time.

### Technical Solution

It is, therefore, an object of the present invention to provide an apparatus for performing a finger-pressure treatment, which has such an excellent finger-pressure treatment effect equal as a human finger-pressure treatment effect obtained by pressurizing a body part with an operation using human fingers and, further, can be conveniently used for a long period of time with less efforts by avoiding additional efforts to press finger-pressure protuberances to the body part.

In accordance with the present invention, there is provided an apparatus for performing a finger-pressure treatment on a body part, the apparatus including: a first finger-pressure rod to be in contact with one surface of the body part; a second finger-pressure rod for applying press on an opposite surface of the body part substantially opposite to said one surface; a driving unit for generating a rotational force; a rotation axle connected to an end portion of the second finger-pressure rod, for transmitting the rotational force of the driving unit to the second finger-pressure rod; an elastic member which is connected to an end portion of the first finger-pressure rod and applies an elastic force to the first finger-pressure rod in such manner that the first finger-pressure rod is rotated in a first direction opposite to a second direction in which the press of the second finger-pressure rod applied on the body part; and a mounting plate on which the rotation axle is rotatably mounted and the elastic member is mounted, wherein the rotation axle is rotatably inserted into the end portion of the first finger-pressure rod, so that the rotational force of the driving unit is prevented from being transmitted to the first finger-pressure rod.

### Advantageous Effects

In accordance with the preferred embodiments of the present invention, since free end portions of the first and the second finger-pressure rod press a body part as if human fingers do, an excellent finger-pressure treatment effect can be attained. Further, the finger-pressure apparatus of the present invention can be constantly and conveniently used with less efforts without applying an additional force required to push the conventional finger-pressure apparatus.

### BRIEF DESCRIPTION OF THE DRAWINGS

The above and other objects and features of the present invention will becomes apparent from the following description of preferred embodiments given in conjunction with accompanying drawings, in which:

FIG. 1 is a cross-sectional view showing a conventional apparatus for performing a finger-pressure treatment;

FIG. 2 shows a perspective view illustrating an apparatus for performing a finger-pressure treatment in accordance with a first preferred embodiment of the present invention;

FIG. 3 illustrates a sectional side view depicting the apparatus for performing a finger-pressure treatment in accordance with the first preferred embodiment of the present invention;

FIG. 4 describes a top view showing principal parts of the apparatus for performing a finger-pressure treatment in accordance with the first preferred embodiment of the present invention;

FIG. 5 provides a block diagram illustrating the apparatus for performing a finger-pressure treatment in accordance with the first preferred embodiment of the present invention;

FIG. 6 presents a diagram depicting various preferred embodiments of a finger-pressure tip of the apparatus for performing a finger-pressure treatment in accordance with the first preferred embodiment of the present invention;

FIGS. 7 to 9 represent operation states of the apparatus for performing a finger-pressure treatment in accordance with the first preferred embodiment of the present invention;

FIG. 10 describes a perspective view showing an apparatus for performing a finger-pressure treatment in accordance with a second preferred embodiment of the present invention;

FIG. 11 depicts a perspective view illustrating an interior of the apparatus for performing a finger-pressure treatment in accordance with the second preferred embodiment of the present invention;

FIG. 12 provides a block diagram depicting the apparatus for performing a finger-pressure treatment in accordance with the second preferred embodiment of the present invention;

FIG. 13 shows a top view of a guide groove of the apparatus for performing a finger-pressure treatment in accordance with the second preferred embodiment of the present invention;

FIG. 14 offers a top view showing a guide protrusion of the apparatus for performing a finger-pressure treatment in accordance with the second preferred embodiment of the present invention;

FIGS. 15 to 17 present diagrams describing operation states of the apparatus for performing a finger-pressure treatment in accordance with the second preferred embodiment of the present invention;

FIG. 18 shows a perspective view illustrating an apparatus for performing a finger-pressure treatment in accordance with a third preferred embodiment of the present invention;

FIG. 19 illustrates a perspective view depicting an interior of the apparatus for performing a finger-pressure treatment in accordance with the third preferred embodiment of the present invention;

FIG. 20 describes a block diagram showing the apparatus for performing a finger-pressure treatment in accordance with the third preferred embodiment of the present invention;

FIGS. 21 to 23 present top views showing an operation of the apparatus for performing a finger-pressure treatment in accordance with the third preferred embodiment of the present invention;

FIGS. 24 to 26 represent bottom views illustrating the operation of the apparatus for performing a finger-pressure treatment in accordance with the third preferred embodiment of the present invention;

FIG. 27 offers a top view illustrating a worm gear assembly of the apparatus for performing a finger-pressure treatment in accordance with the third preferred embodiment of the present invention; and

FIG. 28 sets forth a side view showing the worm gear assembly of the apparatus for performing a finger-pressure treatment in accordance with the third preferred embodiment of the present invention.

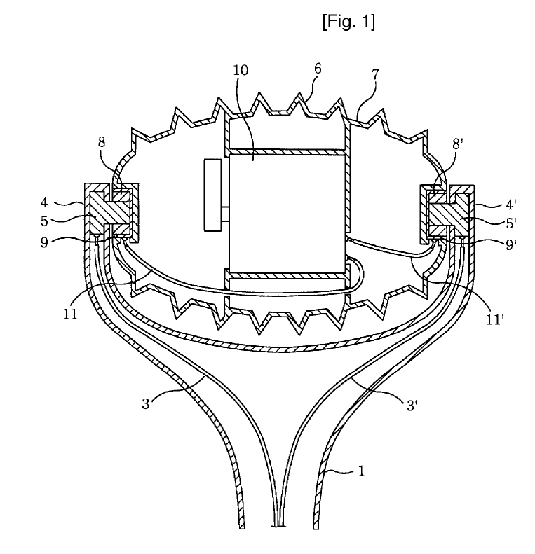

### BEST MODE FOR CARRYING OUT THE INVENTION

Hereinafter, most preferred embodiments of the present invention will be described in detail with reference to the accompanying drawings so that they can be easily implemented by those skilled in the art of the present invention.

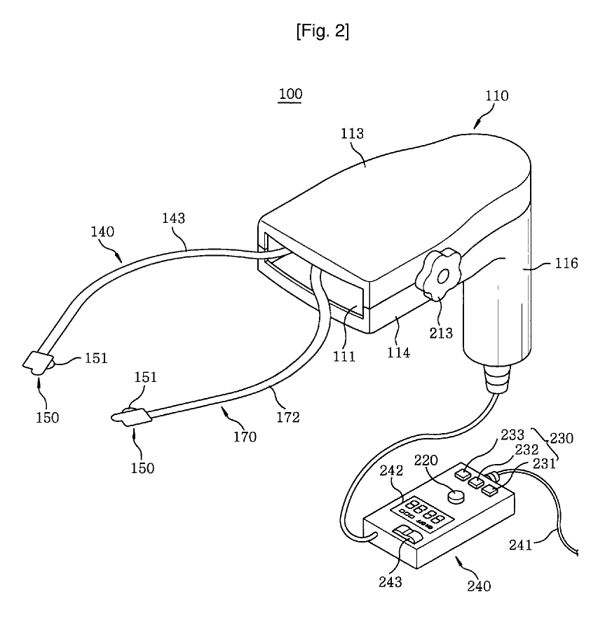

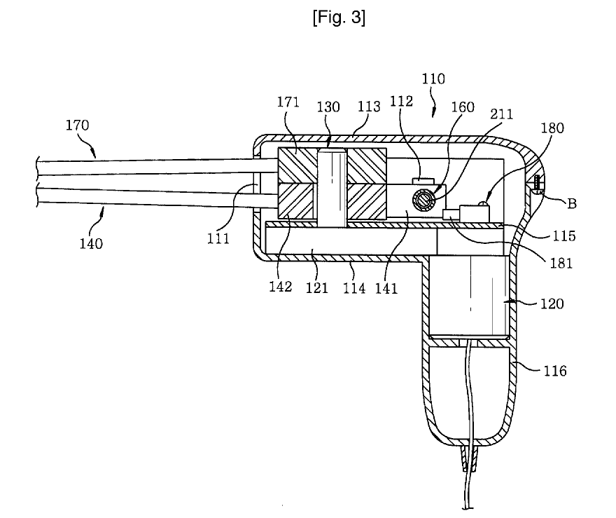

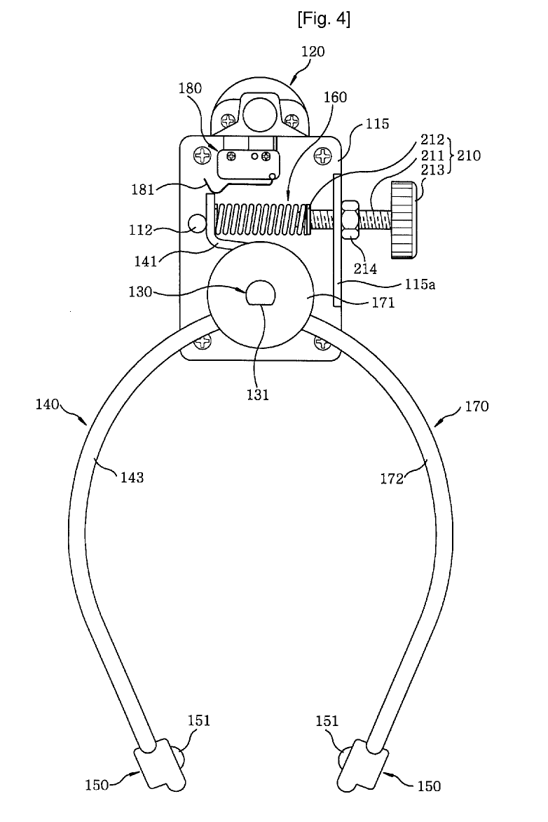

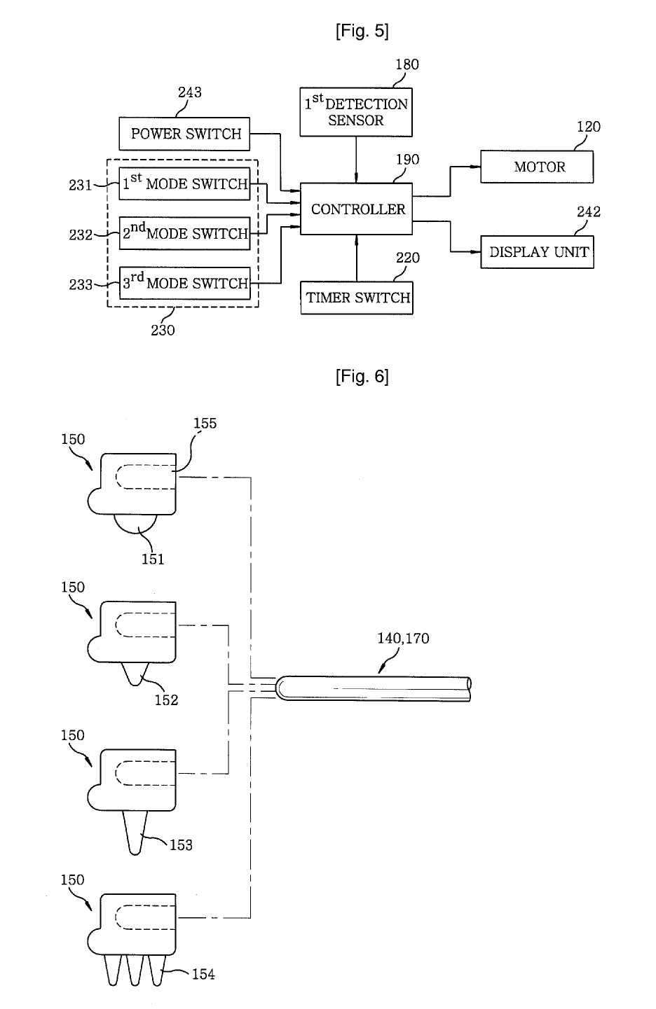

FIG. 2 shows a perspective view illustrating an apparatus for performing a finger-pressure treatment in accordance with a first preferred embodiment of the present invention; FIG. 3 illustrates a cross-sectional view depicting the apparatus for performing a finger-pressure treatment in accordance with the first preferred embodiment of the present invention; FIG. 4 describes a top view showing principal parts of the apparatus for performing a finger-pressure treatment in accordance with the first preferred embodiment of the present invention; and FIG. 5 provides a block diagram illustrating the apparatus for performing a finger-pressure treatment in accordance with the first preferred embodiment of the present invention.

As illustrated in the aforementioned drawings, the apparatus for performing a finger-pressure treatment (or a finger-pressure apparatus) 100 in accordance with the first preferred embodiment of the present invention includes a casing 110 having an opening 111 formed at one side thereof; a first and a second finger-pressure rod 140 and 170 that are rotatably coupled inside the casing 110 and protruded through the opening 111 in such a manner that free end portions thereof face each other; a motor 120 installed inside the casing 100, for rotating the second finger-pressure rod 170; a spring 160 for providing an elastic force to the first finger-pressure rod 140; a detection sensor 180 for outputting a detection signal by the rotation of the first finger-pressure rod 140; and a controller 190 for controlling the motor 120 by receiving the detection signal outputted from the detection sensor 180.

The casing 110 has the opening 111 formed at one side thereof and, further, is divided into an upper and a lower casing portion 113 and 114 vertically assembled by a plurality of screws B so that the interior thereof can be opened, wherein a mounting plate 115 and a stopper 112 are provided therein.

The stopper 112 restricts a rotation of the free end portion of the first finger-pressure rod 140 to a certain angle by limitting a rotation of the other end portion of the first finger-pressure rod 140. To do so, the stopper 112 can be vertically formed on an inner surface of the casing 110 as a unit or installed inside the casing 110. In the embodiment shown in FIGS. 3 and 4, the stopper 112 is vertically fixed on the mounting plate 115 by using screws or the like so as to be installed inside the casing 110.

A handle grip 116 is formed at the lower casing portion 114 so that a user can conveniently grip the casing 110, and the motor 120 is provided inside the handle grip 116. Further, the casing 110 can have axles for each of the first and the second finger-pressure rod 140 and 170 in order to rotatably couple end portions of the first and the second finger-pressure rod 140 and 170 thereto. Referring to FIGS. 3 and 4, the first and the second finger-pressure rod 140 and 170 are installed inside the casing 110 in such a manner that the end portions thereof are coupled by a single rotation axle 130.

The rotation axle 130 is vertically installed while being mechanically connected to a rotator of the motor 120, so that it can be rotated by an operation of the motor 120. Further, one end portion of the first finger-pressure rod 140 is rotatably coupled thereto, and a flattened portion 131 is formed at one end portion of the second finger-pressure rod 170, so that the second finger-pressure rod 170 can be rotated with the rotation axle 130.

Meanwhile, a reduction gear 121 is preferably installed between the motor 120 and the rotation axle 130 to supply increased rotational force to the rotational axle 130. The reduction gear 121 is constituted by a plurality of gears (not illustrated), which are connected to each other mechanically to connect the rotator (not illustrated) of the motor 120 to the rotation axle 130. Further, the reduction gear 121 is fixed on a lower surface of the mounting plate 115, and the rotation axle 130, mechanically connected to the reduction gear 121, is vertically protruded from an upper surface of the mounting plate 115 while penetrating the mounting plate 115.

The first finger-pressure rod 140 is protruded through the opening 111 of the casing 110. Further, a rotating block 142 formed as a unit at the other end portion of the first finger-pressure rod 140 is fitted with the rotation axle 130, so that the other end portion of the first finger-pressure rod 140 can be rotatably coupled inside the casing 110 within a certain angle range. Furthermore, if the free end portion of the first finger-pressure rod 140 protruded through the opening 111 of the casing 110 rotates inwardly at a predetermined angle, a pressing member 141 formed as a unit at an outer peripheral surface of the rotating block 142 is engaged with the stopper 112, which restricts the rotation of the first finger-pressure rod 140. Moreover, a spring 160 is installed at the pressing member 141.

The spring 160, i.e., a coil spring, is installed inside the casing 110 and provides an elastic force to the pressing member 141 of the first finger-pressure rod 140 so that the pressing member 141 is elastically biased into engagement with the stopper 112. In other words, when the free end portion of the second finger-pressure rod 140 presses a body part by the rotation of the motor 120 in a state where the body part is positioned between the free end portions of the first and the second finger-pressure rod 140 and 170, the elastic force is provided to the pressing member 141 of the first finger-pressure rod 140 so that the free end portions of the first finger-pressure rod 140 can elastically support the body part.

In order to install the spring 160 inside the casing 110, one end of the spring 160 is supported at a fixing flange 115a vertically formed at one side of the mounting plate 115 and, the other end thereof is inserted into a protrusion (not shown) formed at the pressing member 141 of the first finger-pressure rod 140.

A coupling block 171 formed as a unit at an end portion of the second finger-pressure rod 170 forms an insertion hole (not illustrated) whose shape is equal to a cross section of the rotation axle 130 having the flattened portion 131 so that the end portion of the second finger-pressure rod 170 can be rotatably coupled inside the casing 110. Accordingly, the second finger-pressure rod 170 is rotated with the rotation axle 130 while being fitted with the rotation axle 130. Further, the free end portion of the second finger-pressure rod 170 is protruded through the opening 111 of the casing 110 so as to face the free end portion of the first finger-pressure rod 140. The inward rotation of the second finger-pressure rod 170, which is caused by an operation of the motor 120, enables a finger-pressure treatment to be performed on the body part positioned between the free end portions of the first and the second finger-pressure rod 140 and 170.

The first and the second finger-pressure rod 140 and 170 have arc-shaped curved sections 143 and 172 facing each other. Therefore, when the free end portions of the first and the second finger-pressure rod 140 and 170 perform a finger-pressure treatment, an interference of the first and the second finger-pressure rod 140 and 170 with the body part is minimized.

Finger-pressure tips 150 are detachably coupled to the free end portions of the first and the second finger-pressure rod 140 and 170. Further, as illustrated in FIG. 6, finger-pressure protrusions 151 to 154 having various shapes for an effective finger-pressure treatment depending on parts and levels of a finger-pressure treatment are formed at one side surfaces of the finger-pressure tips 150. Moreover, the finger-pressure tips 150 are exchangeably coupled to the free end portions of the first and the second finger-pressure rod 140 and 170.

Further, a finger-pressure level adjusting device 210 is preferably provided in order to adjust a level of the finger-pressure treatment by controlling the elastic force provided to the first finger-pressure rod 140 positioned at an opposite side of the second finger-pressure rod 170 pressing a body part with an operation of the motor 120, wherein the elastic force is controlled by adjusting a length of the spring 160.

In the finger-pressure level adjusting device 210 of this embodiment shown in FIG. 4, an adjusting bolt 211 inserted into an end portion of the spring 160 for supporting one side of the first finger-pressure rod 140, i.e., the pressing member 141, is screwed and fixed to the fixing flange 115a of the mounting plate 115 installed inside the casing 110. Further, the end portion of the adjusting bolt 211 is exposed after penetrating the casing 110. Furthermore, a supporting washer 212 for supporting the end portion of the spring 160 is fixedly coupled to the adjusting bolt 211. Accordingly, the supporting washer 212 moves with the adjusting bolt 211 by the rotation of the adjusting bolt 211. As a result, by adjusting the length of the spring 160, it is possible to control the elastic force provided to the first finger-pressure rod 140 for elastically supporting an opposite side of the body part pressed by the free end portion of the second finger-pressure rod 170, thereby controlling a level of the finger-pressure treatment.

Meanwhile, a knob 213 is preferably provided at the end portion of the adjusting bolt 211 exposed from the casing 110 and enables an easy rotation of the adjusting bolt 211. Besides, the adjusting bolt 211 is clamped with a fixed nut 214, so that its linear movement is guided when being screwed through the fixing flange 115a of the mounting plate 115.

When the end portion of the first finger-pressure rod 140 pushed by a body part pressed by an inward rotation of the free end portion of the second finger-pressure rod 170, which is caused by an operation of the motor 120, is outwardly rotated while positioning the body part for a finger-pressure treatment between the free end portions of the first and the second finger-pressure rod 140 and 170, the first detection sensor 180 installed on the mounting plate 115 detects it and then outputs a detection signal.

The first detection sensor 180 can be constituted by an optical sensor for outputting the detection signal by receiving or blocking light depending on positions of the pressing member 141. However, in this embodiment shown in FIGS. 3 and 4, it is preferable that the first detection sensor is constituted by a switch 180 being turned on/off depending on whether or not it is in contact with the pressing member 141. The switch 180 has a connection element 181 at one side thereof so as to be turned on when being in contact with the pressing member 141. If the connection element 181 is pushed by the pressing member 141, the switch 180 is connected to another connection element (not shown), so that a power is turned on, and the detection signal is outputted. Further, the connection element 181 formed in a curved shape has an elastic force enabling the connection element 181 separated from the pressing member 141 to return to an original position.

The controller 190 receives the detection signal of the first detection sensor 180 and then controls the motor 120 to add or reduce a force repeatedly applied to a body part by the first and the second finger-pressure rod 140 and 170, i.e., by the free end portions of the first and the second finger-pressure rod 140 and 170. An operation of the controller 190 will be described in detail later.

Meanwhile, as shown in FIG. 5, the finger-pressure apparatus 100 in accordance with the present invention can have a timer switch 220 for setting an operation time and a mode switch 230 for varying a rotation speed of the motor 120.

Further, after the operation time of the timer switch 220 set by an operation has elapsed, a stop signal is outputted from the timer switch 220 to the controller 190 so that the controller 190 can stop the motor 120 rotating. The mode switch 230 outputs various mode signals to the controller 190 by an operation so that the controller 190 can vary the rotation speed of the motor 120 depending on preset values according to the received mode signals. Although the mode switch 230 can be constituted by a single switch, in this embodiment shown in FIGS. 2 to 5, it is constituted by a first to a third mode switch 231 to 233 for outputting different mode signals for differently varying the rotation speed of the motor 120 for the convenience.

The timer switch 220 and the mode switch 230 can be installed at the casing 110. However, in this preferred embodiment shown in FIG. 2, they are installed at one side surface of a remote control 240 provided on a power cord 241 connected to the casing 110 to supply a power thereto. The remote control 240 includes a display unit 242 formed of a liquid crystal display for allowing the user to check operating contents and a power switch 243 for turning on/off a power.

Hereinafter, an operation of the apparatus for performing a finger-pressure treatment 100 in accordance with the first preferred embodiment of the present invention will be described.

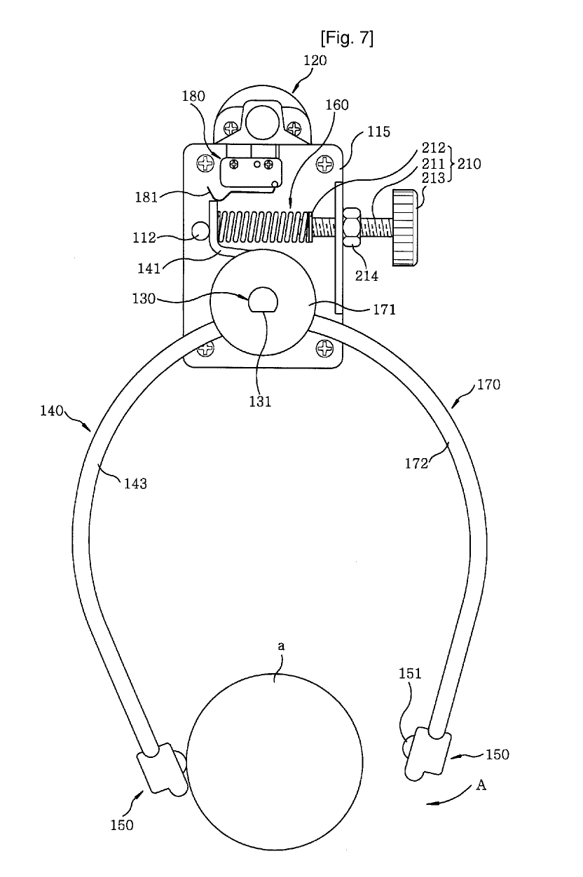

First, a power is supplied by turning on the power switch 243. Then, by gripping the handle grip 116, a body part (a) (indicated as a circle for the convenience of the explanation) to be massaged is positioned between the finger-pressure tips 150 coupled to the free end portions of the first and the second finger-pressure rod 140 and 170. Thereafter, a rotational force obtained by forwardly rotating the motor 120 is transmitted to the rotation axle 130 via the reduction gear 121. Accordingly, as shown in FIG. 7, when the free end portion of the second finger-pressure rod 170 rotates in an “A” direction (inward direction), the finger-pressure protrusion 151 of the finger-pressure tip 150 coupled to the free end portion of the second finger-pressure rod 170 presses and pushes the body part (a) to the finger-pressure protrusion 151 of the finger-pressure tip 150 of the first finger-pressure rod 140, thereby performing a finger-pressure treatment on the body part (a).

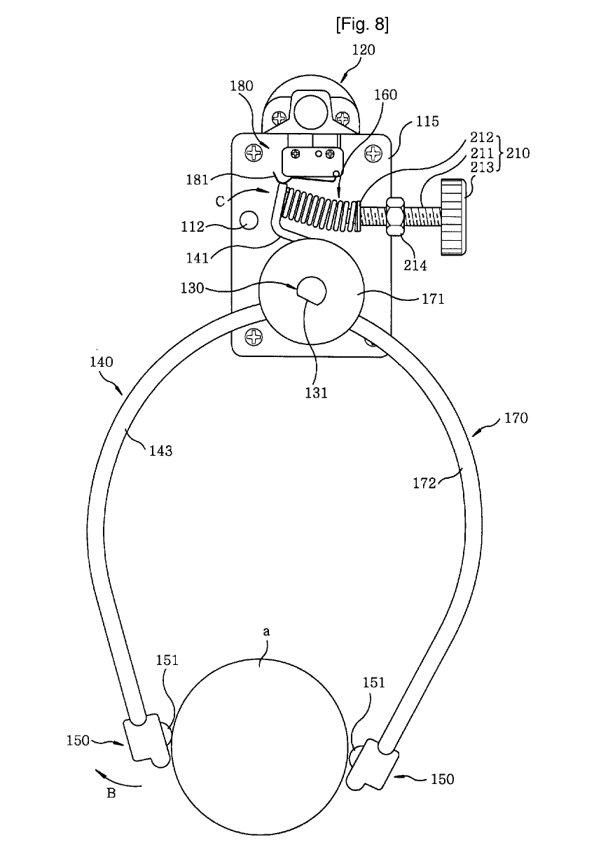

As illustrated in FIG. 8, if a force exceeding a certain level is applied to the body part (a) by the finger-pressure tip 150 of the second finger-pressure rod 170, the finger-pressure tip 150 of the free end portion of the first finger-pressure rod 140 is pushed in a “B” direction (outward direction). Accordingly, the first finger-pressure rod 140 rotates and, then, the pressing member 141 of the first finger-pressure rod 140 rotates in a “C” direction, thereby pressing the connection element 181 of the first detection sensor (switch) 180 while compressing the spring 160.

The first detection sensor 180 is connected to another connection element (not shown) by the press of the connection element 181, thereby precisely detecting a rotation position of the pressing member 141 and then outputting the detection signal to the controller 190.

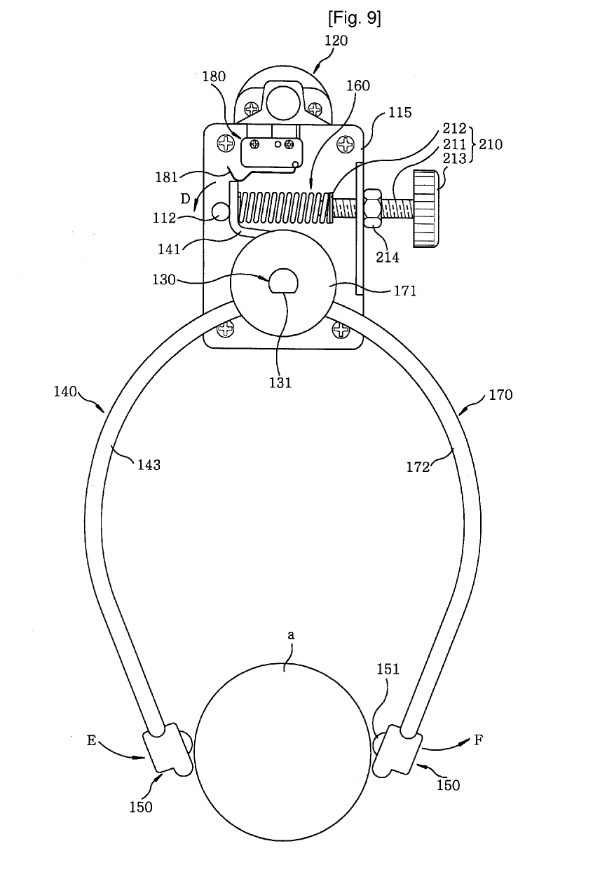

The controller 190 stops the operation of the motor 120 by the detection signal outputted from the first detection sensor 180 and then rotates the motor 120 in an opposite direction. Accordingly, as illustrated in FIG. 9, the finger-pressure tip 150 of the free end portion of the second finger-pressure rod 170 rotates in a “F” direction and, thus, the first finger-pressure rod 140 returns to an original position by the spring 160. Then, the finger-pressure tip 150 of the free end portion of the first finger-pressure rod 140 rotates in an “E” direction and, at the same time, the pressing member 141 rotates in a “D” direction. As a result, the connection element 181 of the detection sensor (switch) 180 is restored by its elastic force, thereby stopping the output of the detection signal to the controller 190.

If the controller 190 does not receive the detection signal from the first detection sensor 180, the motor 120 forwardly rotates again. Then, as shown in FIG. 7, the free end portion of the second finger-pressure rod 170 rotates in the “A” direction (inward direction) and, therefore, the finger-pressure tip 150 of the free end portion thereof presses and pushes the body part (a) to the finger-pressure tip 150 of the first finger-pressure rod 140, thereby performing a finger-pressure treatment. By repeatedly performing such operations, the finger-pressure treatment is repeatedly performed on the body part a.

Further, if the knob 213 of the finger-pressure level adjusting device 210 is turned, the supporting washer 212 moves with the adjusting bolt 211 by the rotation of the adjusting bolt 211, thereby adjusting a length of the spring 160. By adjusting the length of the spring 160, it is possible to control the elastic force provided to the first finger-pressure rod 140 for elastically supporting an opposite side of the body part (a) pressed and pushed by the free end portion of the second finger-pressure rod 170. As a result, a level of the finger-pressure treatment is conveniently controlled.

Further, by setting the operation time with the timer switch 220 installed at the remote control 240 that is separately provided for the convenience of the operation and the reduction of a weight of the casing 110, it is possible to control an operation time of the finger-pressure apparatus 100 in accordance with the present invention. Furthermore, if the controller 190 receives one of the mode signals respectively outputted by the operations of the first to the third mode switches 231 to 233, it varies the speed of the motor 120 depending on the received mode signal, thereby changing frequency of pressing the body part (a).

Moreover, by selectively changing the finger-pressure tips 150 having the finger-pressure protrusions 151 to 154 provided at the free end portions of the first and the second finger-pressure rod 140 and 170 for different free parts and purposes of the finger-pressure treatment, the finger-pressure treatment can be effectively performed.

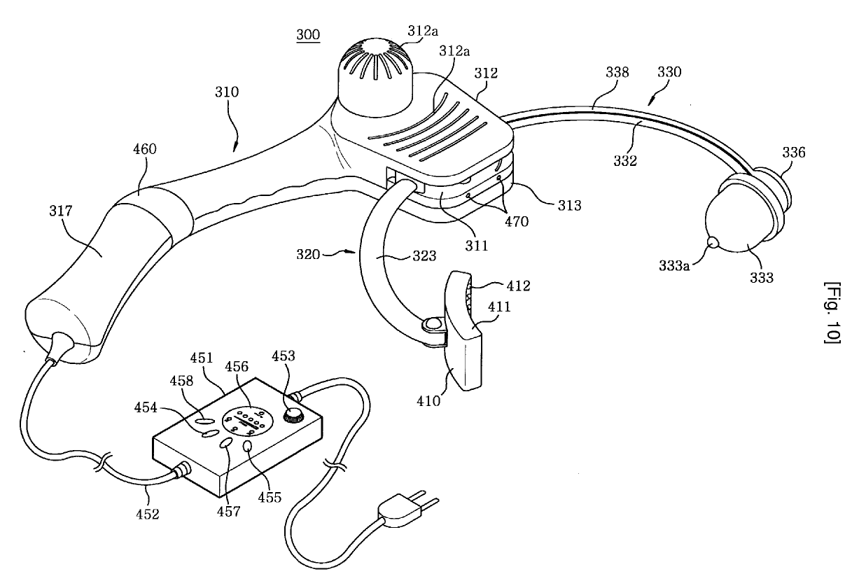

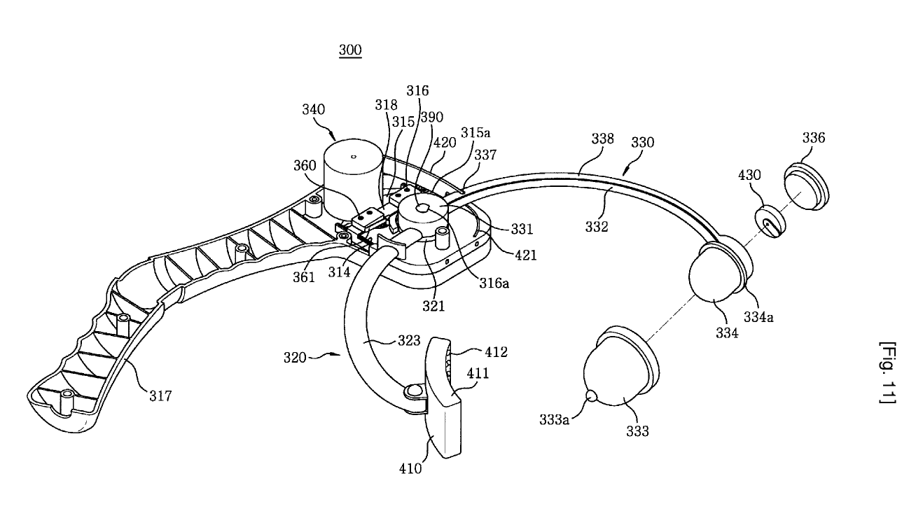

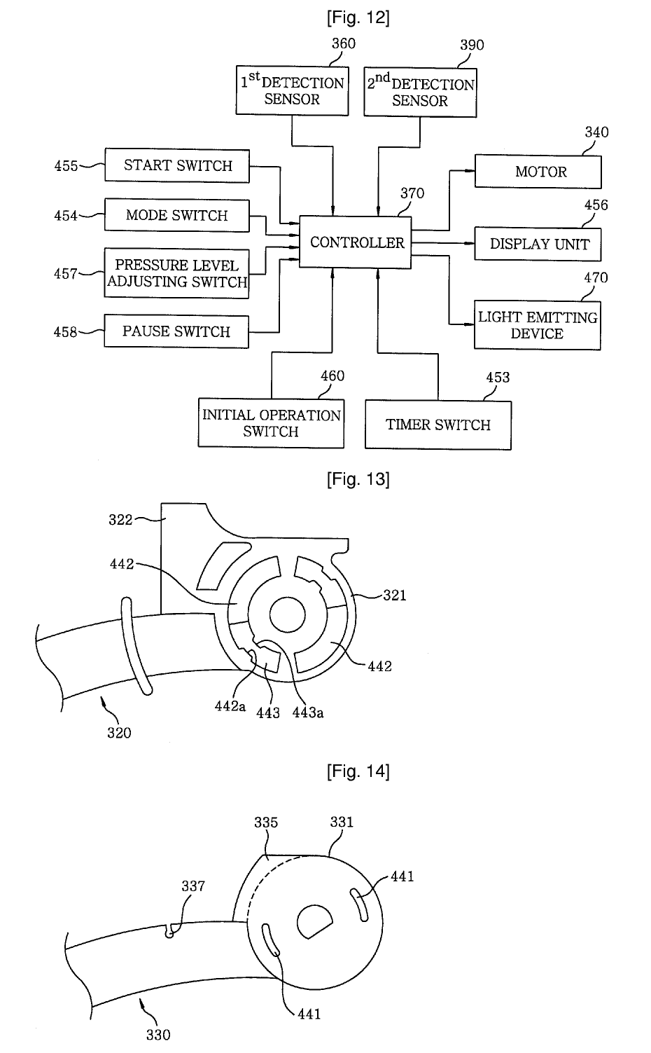

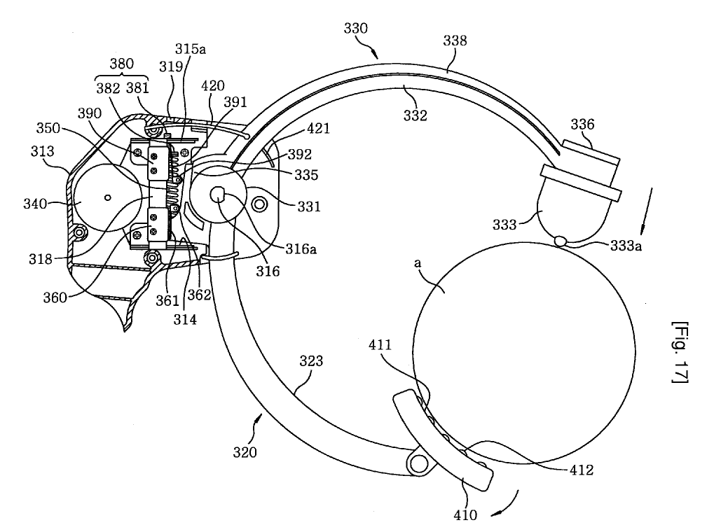

FIG. 10 describes a perspective view showing an apparatus for performing a finger-pressure treatment in accordance with a second preferred embodiment of the present invention; FIG. 11 depicts a perspective view illustrating an inner portion of the apparatus for performing a finger-pressure treatment in accordance with the second preferred embodiment of the present invention; and FIG. 12 provides a block diagram depicting the apparatus for performing a finger-pressure treatment in accordance with the second preferred embodiment of the present invention. As depicted in the aforementioned drawings, the apparatus for performing a finger-pressure treatment (or a finger-pressure apparatus) 300 in accordance with the second preferred embodiment of the present invention includes a casing 310, a first and a second finger-pressure rod 320 and 330, a motor 340, a spring 350 (see FIG. 16) and a first detection sensor 360 and a controller 370.

The casing 310 has an opening 311 (illustrated in FIG. 10) formed at one side thereof and, further, is divided into an upper and a lower casing portions 312 and 313 assembled to each other by a plurality of screws(not shown). Further, a handle grip 317 is formed at a lower portion of the casing 310, and a plurality of heat emission openings 312a for emitting an inner heat to an outside are formed side portions of the casing 310. Besides, a stopper 314 engaged at one side of the first finger-pressure rod 320 is vertically formed as a unit at one side of the mounting plate 315 fixed inside the casing 310 in order to restrict an inward rotation of a free end portion of the first finger-pressure rod 320 to a certain angle.

The first and the second finger-pressure rod 320 and 330 are protruded through the opening 311 (illustrated in FIG. 10) of the casing 310 so that the free end portions thereof can face each other. Further, arc-shaped curved sections 323 and 332 facing each other are formed to minimize their interference with a body part during a finger-pressure treatment. Furthermore, the first and the second finger-pressure rod 320 and 330 are coupled to a rotation axle 316 vertically installed inside the casing 310 while being mechanically connected to a rotator of the motor 340 so that they can be rotated by an operation of the motor 340. The first finger-pressure rod 320 is fitted with the rotation axle 316 in such a manner that the rotation axle 316 is rotatably inserted into a rotating block 321 formed at the other end portion of the first finger-pressure rod 320. Further, the second finger-pressure rod 330 is fixed to the rotation axle 316, so that it can be rotated with the rotation axle 316, wherein a coupling block 331 formed at the other end portion of the second finger-pressure rod 330 is fixedly coupled to a flattened portion 316a formed at the rotation axle 316.

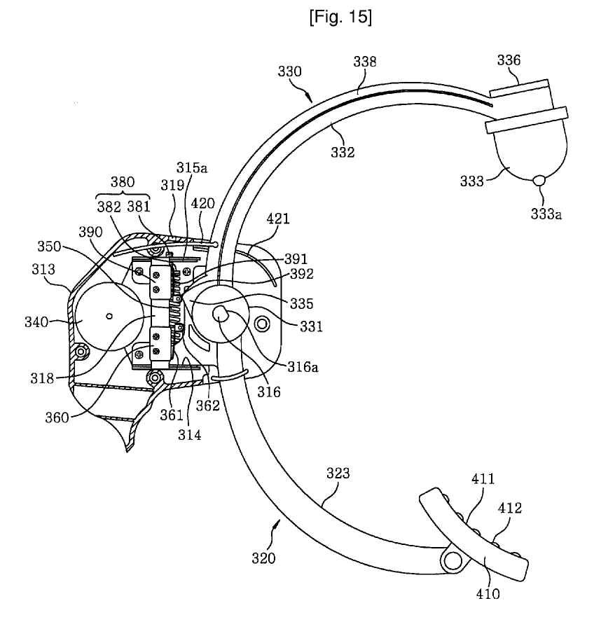

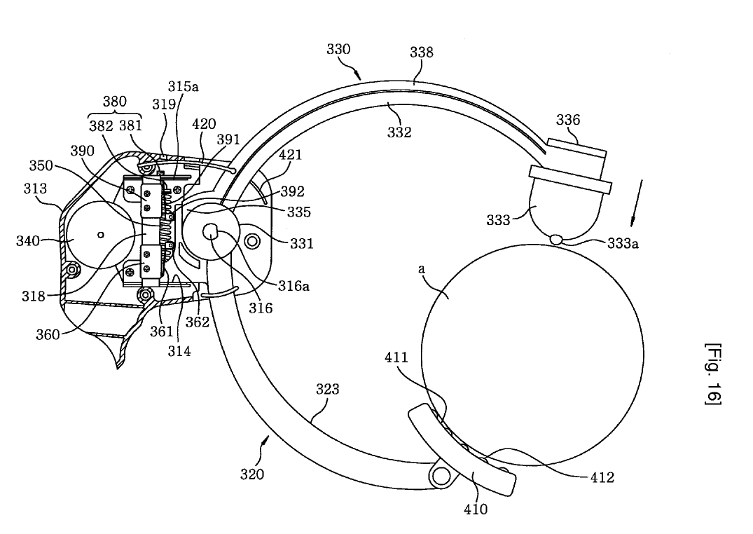

A pressing member 322 (see FIG. 13) is protrudingly formed as a unit at the rotating block 321 to support one end portion of the spring 350 (see FIG. 15). The pressing member 322 is engaged with the stopper 314 when the free end portion of the first finger-pressure rod 320 protruded through the opening 311 (shown in FIG. 8) rotates at a certain angle.

The first finger-pressure rod 320 is provided with a finger-pressure plate 410 formed in an arc shape so as to enlarge a contact portion of its contact surface 411 to be in contact with a body part. Moreover, the finger-pressure plate 410 in which finger-pressure protrusions 412 are formed on the contact surface 411 is hinge-coupled to the free end portion of the first finger-pressure rod 320. The finger-pressure plate 410 is made of a material having an elasticity such as rubber or the like in order to enable a smooth contact with a body part. Further, the finger-pressure plate 410 can also be installed at the second finger-pressure rod 330.

A protection cover 420 (see FIG. 11) is preferably provided to prevent fingers carelessly inserted into the opening 311 of the casing 310 from being injured by the rotation of the second finger-pressure rod 330 or foreign substances such as dusts or the like from being inserted inwardly through the opening 311. The protection cover 420 is slidably inserted into a sliding groove 421 formed at the casing 310, i.e., the upper and the lower casing portion 312 and 313, adjacently along the opening 311 and, further, one end of the protection cover 420 is coupled to the second finger-pressure rod 330 while being inserted into a coupling groove 337 formed at the second finger-pressure rod 330. Therefore, when the second finger-pressure rod 330 rotates, the protection cover 420 constantly blocks a portion of the opening 311 along which the second finger-pressure 330 has passed, while sliding along the sliding groove 421 together with the second finger-pressure rod 330.

A finger-pressure tip 333 formed of an elastic material such as rubber or the like is detachably coupled to the free end portion of the second finger-pressure rod 330. To do so, an insertion portion 334 (see in FIG. 11) is formed at the free end portion thereof and, further, an engaging projection 334a formed at an outer peripheral surface of the insertion portion 334 is engaged with an engaging groove (not shown) formed at an inner peripheral surface of the finger-pressure tip 333. Moreover, as in the first embodiment, the finger-pressure tip 333 is provided with the finger-pressure protrusion 333a having various shapes depending on body parts to be massaged or levels of a finger-pressure treatment for an effective finger-pressure treatment, wherein the finger-pressure tip 333 can be changed if necessary.

A vibration motor 430 is preferably installed at the free end portion of the second finger-pressure rod 330, i.e., inside the insertion portion 334 (see FIG. 11) so as to improve a finger-pressure treatment effect. In order to install the vibration motor 430, the insertion portion 334 has therein a mounting space (not shown) for installing the vibration motor 430, and the mounting space is sealed by a lid 336. In addition, a power supply line (not illustrated) for supplying a power to the vibration motor 430 can be installed while penetrating the interior of the insertion portion 334. Or, it is also possible to insert a power supply line into a cable insertion groove 338 formed along a length direction of the second finger-pressure rod 330 and then perform a molding process on the cable insertion groove 338.

In order to prevent the free end portions of the first and the second finger-pressure rod 320 and 330 from being excessively close to each other and then causing injury to a body part during the finger-pressure treatment, as illustrated in FIGS. 13 and 14, guide protrusions 441 are formed in any one of surfaces of the rotating block 321 and the coupling block 331. Further, guide grooves 442 for restricting a moving range of the guide protrusions 441 are formed on the other surface so that the guide protrusions 441 can be inserted thereinto. In this embodiment, the guide protrusions 441 and the guide grooves 442 are provided as one pair, respectively. Further, the guide grooves 442 and the guide protrusions 441 are formed at the rotating block 321 of the first finger-pressure rod 320 and the coupling block 331 of the second finger-pressure rod 330, respectively.

Moreover, elastic members 443 are installed in the guide grooves 442 to prevent the guide protrusions 441 moving along the guide grooves 442 from being damaged by an impact from a collision with the inside of the guide grooves 442 and, further, to keep the first detection sensor 360 and a second sensor 390 to be described later from being damaged by the pressing members 322 and 335 respectively formed at one of the first and the second finger-pressure rod 320 and 330. By inserting coupling protrusions 442a formed in the guide grooves 442 into combining grooves 443a formed at both sides of the elastic members 443, the elastic members 443 are fixed in a portion of the guide grooves 442 with which the guide protrusions 441 engages when the pressing members 332 and 335 of the first and the second finger-pressure rod 320 and 330 press the first and the second detection sensor 360 and 390.

The motor 340 is fixed to the lower casing portion 313 and, further, can rotate the rotation axle 316 fixed with the second finger-pressure rod 330 by using any one of various power transmission units. In this case, as in the first embodiment, the rotator of the motor 340 is mechanically connected to the rotation axle 316 to the rotation axle 316 by a reduction gear (not shown) installed at a lower portion of the mounting plate 315 in order to transmit an increased rotational force thereto.

When the finger-pressure treatment is performed, one end of the spring 350 is supported at the fixing flange 315a vertically formed at one side of the mounting plate 315 so that the first finger-pressure rod 320 can elastically support a massaged body part and, in such state, the other end of the spring 350 is inserted into a protrusion (not shown) formed at the pressing member 322 of the first finger-pressure rod 320. Further, a finger-pressure level adjusting device 380 (shown in FIGS. 15 to 17) adjusts an elastic force provided to the first finger-pressure rod 320.

The finger-pressure level adjusting device 380 (shown in FIGS. 15 to 17) includes an adjusting bolt 381 and a supporting washer 382 as in the first embodiment. However, for an easy rotation of the adjusting bolt 381 exposed through a though hole 319 formed at one side of the casing 310, a “+” or “−” shaped groove (not shown) is formed at a top end portion of the adjusting bolt 381. Thus, the adjusting bolt 381 can be easily turned by using a driver or the like.

When the free end portion of the first finger-pressure rod 320 pushed by a body part pressed by an inward rotation of the free end portion of the second finger-pressure rod 330, which is caused by an operation of the motor 340, outwardly rotates while positioning the body part (a) for a finger-pressure treatment between the free end portions of the first and the second finger-pressure rod 320 and 330, the first detection sensor 360 detects a press of the pressing member 322 of the first finger-pressure rod 320 and then outputs the detection signal to the controller 370 (illustrated in FIG. 12). Further, the first detection sensor 360 is installed at an upper portion of the mounting plate 315 while being fixed to the fixing bracket 318 coupled to both sides of the mounting plate 315 by screws or the like.

Further, the second detection sensor 390 can be provided in order that the controller 370 can easily control the motor 340 to position the body part between the free end portions of the first and the second finger-pressure rod 320 and 330 for a finger-pressure treatment by the outward rotation of the free end portion of the second finger-pressure rod 330.

The second detection sensor 390 is arranged in a row with the first detection sensor 360 at the upper portion of the mounting plate 315 by the fixing bracket 318. Further, when a body part requiring a finger-pressure treatment is positioned between the free end portions of the first and the second finger-pressure rod 320 and 330 by the outward rotation of the free end portion of the second finger-pressure rod 330, the second detection sensor 390 is brought in contact with the pressing member 335 of the second finger-pressure rod 330 and then outputs a detection signal to the controller 370.

The first and the second detection sensor 360 and 390 have connection elements 361 and 391, which are pressed by the pressing members 322 and 335 provided at the other end portions of the rotating first and second finger-pressure rod 320 and 330, the connection elements 361 and 391 having an elastic force for a restoration. Further, the first and the second detection sensor 360 and 390, i.e., switches being turned on/off depending on whether or not the connection elements 361 and 391 are pressed, have rotatable rollers 362 and 392 (shown in FIGS. 15 to 17) at the end portions of the connection elements 361 and 391 for an efficient contact with the pressing members 322 and 335 of the first and the second finger-pressure rod 320 and 330.

The controller 370 (illustrated in FIG. 12) controls the motor 340 by receiving the detection signals of the first and the second detection sensor 360 and 390, thereby increasing or reducing a force applied to a body part under a finger-pressure treatment performed by the first and the second finger-pressure rod 320 and 330.

In the finger-pressure apparatus 300 in accordance with this embodiment, a remote control 451 provided on a power cord 452 (see FIG. 10) connected to the casing 310 to supply a power is provided with a timer switch 453 for setting an operation time; a mode switch 454 for changing frequency of pressing the body part by controlling a rotation speed of the motor 340; a start switch 455 for a driving; a pressure level adjusting switch 457 for changing a rotational force of the motor 340; a pause switch 458; a vibration motor operating switch (not shown); and a display unit 456.

Further, in order to perform a finger-pressure treatment, the free end portions of the first and the second finger-pressure rod 320 and 330 need to be outwardly opened so that a body part requiring a finger-pressure treatment can be inserted thereinto. Accordingly, the controller 370 can control the motor 340 for a preset period of time so that the free end portions of the first and the second finger-pressure rod 320 and 330 can be opened while the start switch 455 is turned on. However, an initial operation switch 460, i.e., a type of a touch switch operated by a user's contact, for outputting a signal to the controller 370 is preferably provided at the handle grip 317 of the casing 310. In other words, the initial operation switch 460 outputs a signal enabling the controller 370 to control the motor 340 so that a body part requiring a finger-pressure treatment can be positioned between the free end portions of the first and the second finger-pressure rod 320 and 330 by the outward rotation of the free end portion of the second finger-pressure rod 330.

Additionally, there can be further provided a light emitting device 470 for emitting light according to control signals of the controller 370 when a finger-pressure treatment is performed by driving the motor 340 with the controller 370 (shown in FIG. 12). The light emitting device 470, which is constituted by a pair of lamps provided at one side of the casing 310 in this embodiment, is turned on and off by turns during the finger-pressure treatment.

Hereinafter, an operation of the finger-pressure apparatus 300, which has the aforementioned configuration, in accordance with the second embodiment of the present invention will be described.

First, if the start switch 455 is turned on and, further, the initial operation switch 460 is also turned on by the contact, the controller 370 drives the motor 340. Accordingly, as illustrated in FIG. 15, the free end portion of the second finger-pressure rod 330 outwardly rotates until the pressing member 335 of the second finger-pressure rod 330 presses the connection element 391 of the second detection sensor 390, so that the second detection sensor 390 outputs the detection signal. As a result, a body part a requiring a finger-pressure treatment can be positioned between the free end portions of the first and the second finger-pressure rod 320 and 330.

If the body part (a) requiring the finger-pressure treatment is positioned between the free end portions of the first and the second finger-pressure rod 320 and 330, when the initial operation switch 460 is turned off by a noncontact or after a preset period of time has elapsed, the controller 370 drives the motor 340 in a forward or a backward direction as in the first embodiment. Accordingly, as shown in FIGS. 15 to 17, the second finger-pressure rod 330 rotates and, thus, the finger-pressure protrusions 333a and 412 of the finger-pressure tips 333 and the finger-pressure plate 410 repeatedly press the body part (a) to thereby perform a finger-pressure treatment. Further, unlike the first embodiment, when the second detection sensor 390 is pressed by the pressing member 335 of the rotating second finger-pressure rod 330 and then outputs the detection signal, the controller 370 can recognize that the free end portion of the second finger-pressure rod 330 is separated from the body part (a). Then, the controller 370 switches a rotation direction of the motor 340 so that the free end portion of the second finger-pressure rod 330 can press the body part (a) again according to the detection signal outputted from the second detection sensor 390.

Further, the finger-pressure apparatus 300 in accordance with this embodiment controls a level of the finger-pressure treatment by the rotation of the adjusting bolt 381 of the finger-pressure level adjusting controller 380 (shown in FIGS. 15 to 17) as in the first embodiment. Further, the operation time thereof can be set and controlled by the timer switch 453. Furthermore, a frequency of pressing a body part and a level of the finger-pressure treatment can be controlled by the mode switch 454 and the pressure level adjusting switch 457, respectively.

Moreover, the finger-pressure tip 333 can be changed depending on body parts to be massaged and purposes of the finger-pressure treatment. Further, a portion for a finger-pressure treatment is enlarged by the finger-pressure protrusions 412 of the finger-pressure plate 410 most closely adhered to the body part (a) and, then, a vibration is applied to the body part (a) under the finger-pressure treatment with the vibration motor 430, thereby enabling an effective finger-pressure treatment.

As described above, by installing the end portions of the first and the second finger-pressure rod 320 and 330 in the casing 310 with the single rotation axle 316, installation structure of the first and the second finger-pressure rod 320 and 330 are simplified. Further, by restricting the movement of the guide protrusions 441 in the guide grooves 442 during the rotation of the second finger-pressure rod 330, the free end portions of the first and the second finger-pressure rod 320 and 330 are prevented from being excessively close to each other, so that the body part (a) can be protected from injury during the finger-pressure treatment. Further, when the pressing members 322 and 335 press the connection elements 361 and 391 of the first and the second detection sensor 360 and 390 by the outward rotation of the free end portions of the first and the second finger-pressure rod 320 and 330, the guide protrusions 441 becomes in contact with the elastic member 443, thereby preventing the first and the second detection sensor 360 and 390 from being damaged by the pressing member 322 and 335. Additionally, a noise can be prevented.

The protection cover 420 guarantees a safety by preventing fingers or the like from being caught in the opening 311 and then being injured by the rotating second finger-pressure rod 330a. Further, with the protection cover 420, foreign substances are prevented from flowing into the casing 310 through the opening 311 and then causing operation errors.

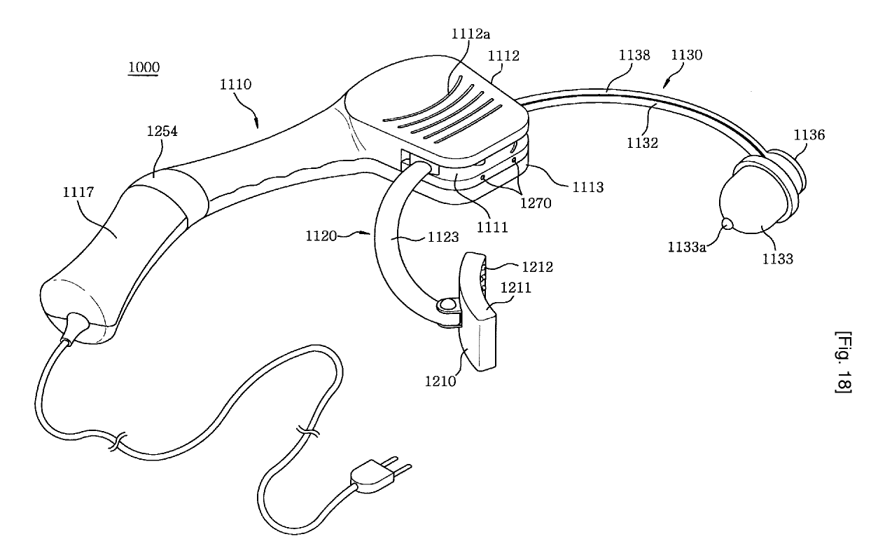

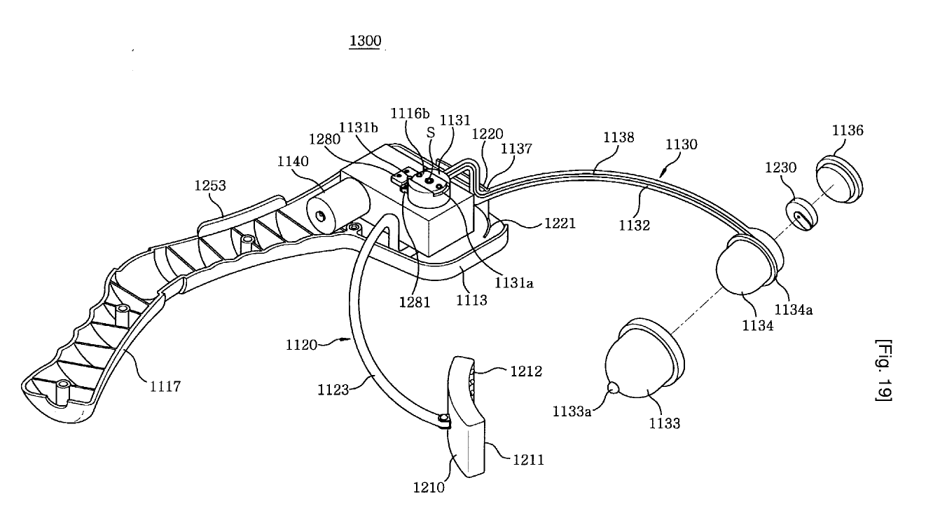

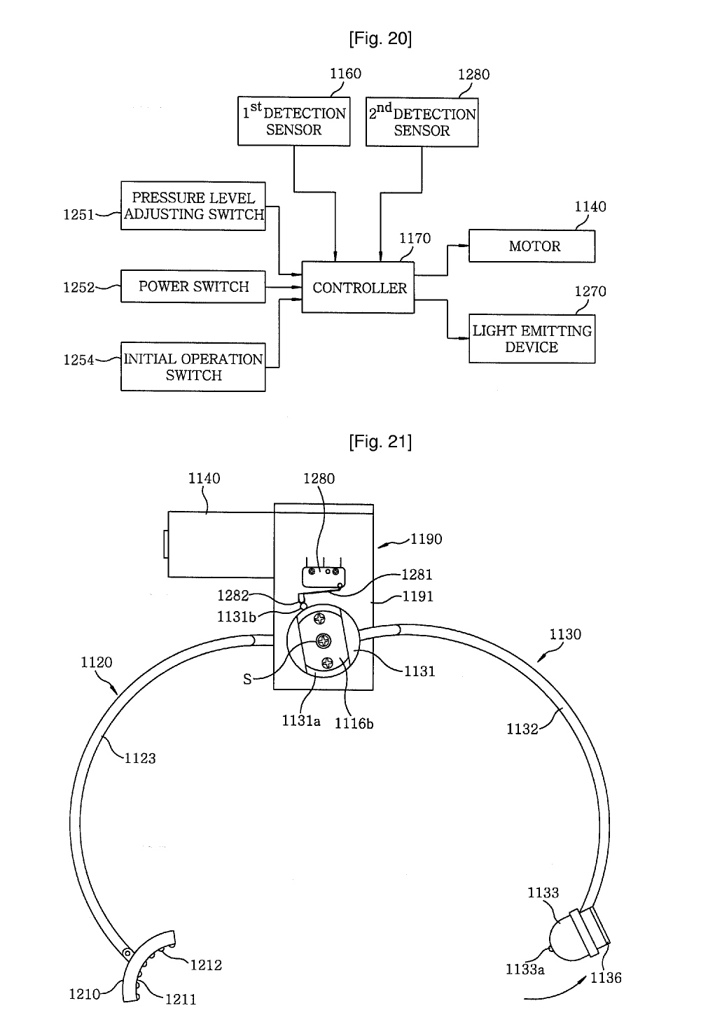

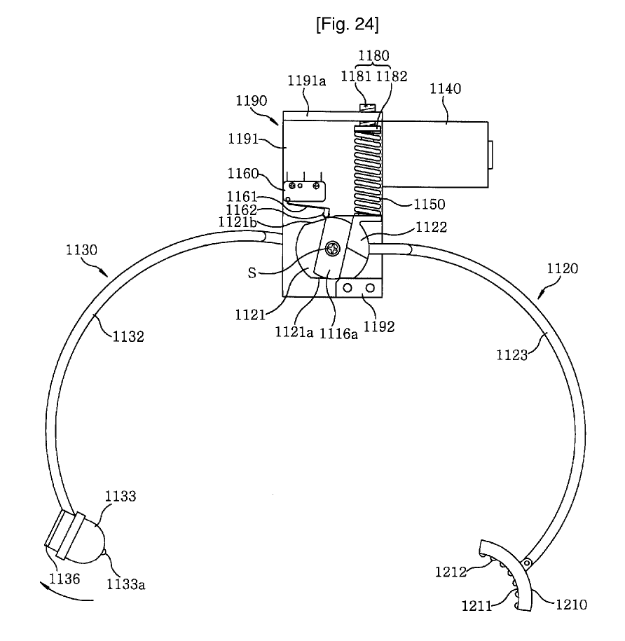

FIG. 18 shows a perspective view illustrating an apparatus for performing a finger-pressure treatment in accordance with a third preferred embodiment of the present invention; FIG. 19 illustrates a perspective view depicting an inner portion of the apparatus for performing a finger-pressure treatment in accordance with the third preferred embodiment of the present invention; and FIG. 20 describes a block diagram of the apparatus for performing a finger-pressure treatment in accordance with the third preferred embodiment of the present invention. As illustrated in the aforementioned drawings, the apparatus for performing a finger-pressure treatment (or a finger-pressure apparatus) 1000 includes a casing 1110; a first and a second finger-pressure rod 1120 and 1130 that are rotatably installed in the casing 1110 and protruded from the casing 1110; an elastic member 1150 (see FIG. 24) for providing an elastic force to the first finger-pressure rod 1120; a motor 1140 for rotating the second finger-pressure rod 1130; a worm gear assembly 1190 for transmitting a rotational force of the motor 1140 to the second finger-pressure rod 1130; a first detection sensor 1160 for detecting a rotation of the first finger-pressure rod 1120; and a controller 1170 for controlling the motor 1140.

The casing 1110 has an opening 1111 formed at one side thereof and, further, is divided into an upper and a lower casing portion 1112 and 1113 assembled to each other by a plurality of screws (not shown). Moreover, a handle grip 1117 is formed at a lower portion of the casing 1110 and a plurality of heat emission openings 1112a for emitting an inner heat to an outside are formed in side portions of the casing 1110.

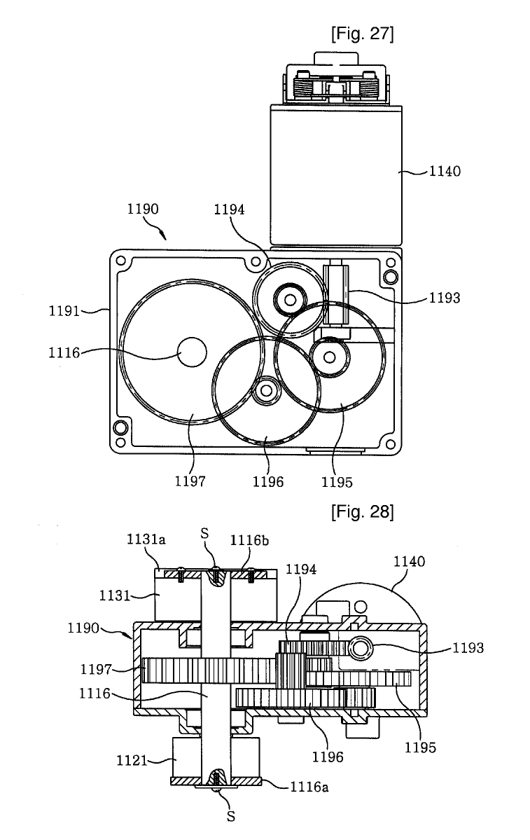

The first and the second finger-pressure rod 1120 and 1130 are coupled to a rotation axle 1116 (see FIG. 28) vertically penetrating a housing 1191 (see FIG. 27) of the worm gear assembly 1190 installed in the casing 1110, so that free end portions of the first and the second finger-pressure rod 1120 and 1130 can be rotatably installed in the casing 1110. Further, the free end portions protruded through the opening 1111 of the casing 1110 face each other, and arc-shaped curved sections 1123 and 1132 facing each other are formed to minimize an interference with a body part during a finger-pressure treatment.

The first and the second finger-pressure rod 1120 and 1130 are coupled to a lower and an upper portion of the rotation axle 1116, respectively. Further, as will be described later, the first finger-pressure rod 1120 is so coupled as to be rotatable about the rotation axle 1116, while the second finger-pressure rod 1130 is so coupled as to rotate with the rotation axle 1116. A cross section of the rotation axle 1116 is formed in an eccentric shape, e.g., an elliptic shape, a circular shape having a flattened part, or the like.

A rotating block 1121 (see FIG. 28) formed at the other end portion of the first finger-pressure rod 1120 is fitted with the rotation axle 1116 and, the first finger-pressure rod 1120 is installed rotatably about the rotation axle 1116 in a state where a separation thereof from the rotation axle 1116 is prevented by a first rotating member 1116a fixed to a lower end of the rotation axle 1116 by a screw S. Further, a coupling block 1131 formed at the other end portion of the second finger-pressure rod 1130 is fixed to the rotation axle 1116 by a screw S while being fitted therewith, so that the second finger-pressure rod 1130 can be installed in a state where a separation thereof from the rotation axle 1116 is prevented by a second rotating body 1116b. With the second rotating member 1116b inserted into a mounting groove 1131a (see FIG. 19) formed at the coupling block 1131, the second finger-pressure rod 1130 rotates with the second rotating member 1116b when the rotation axle 116 rotates.

As illustrated in FIGS. 24 to 26, in the first finger-pressure rod 1120, a pressing member 1122 protrudingly formed as a unit at the rotating block 1121 supports one end of an elastic member 1150. Further, when the first rotating member 1116a rotating with the rotation axle 1116 rotates in an outward direction at more than a preset angle, the pressing member 1122 compresses the elastic member 1150. In order to restrict a range where the free end portion of the first finger-pressure rod 1120 moves toward the free end portion of the second finger-pressure rod 1120 by the elastic force of the elastic member 1150, an engaging surface 1121a horizontally formed at one side of the rotating block 1121 is supported at a stopper 1192 protrudingly installed at the housing 1191 of the worm gear assembly 1190.

A finger-pressure plate 1210 is hinge-coupled to the free end portion of the first finger-pressure rod 1120. The finger-pressure plate 1210 has an arc-shaped contact surface 1211 to enlarge a contact portion to be in contact with a body part. Further, finger-pressure protrusions 1212 are formed on the contact surface 1211. The finger-pressure plate 1210 is made of a material having an elasticity, e.g., rubber or the like, to enable a smooth contact with the body part and, further, can be installed at the second finger-pressure rod 1130 as well as at the first finger-pressure rod 1120.

A protection cover 1220 (shown in FIG. 19) is preferably provided to prevent fingers carelessly inserted into the opening 1111 of the casing 1110 from being injured by the rotation of the second finger-pressure rod 1130 or foreign substances such as dusts or the like from being inserted inwardly through the opening 1111. The protection cover 1120 is slidably coupled to a sliding groove 1121 formed at the casing 1110, i.e., the upper and the lower casing portion 1112 and 1113, adjacently along the opening 1111 and, further, one end of the protection cover 1120 is fixed to the second finger-pressure rod 1130 while being inserted into a coupling groove 1137 formed at the second finger-pressure rod 1130. Therefore, when the second finger-pressure rod 1130 rotates, the protection cover 1120 constantly blocks a portion of the opening 1111 through which the second finger-pressure rod 1130 has passed, while sliding along the sliding groove 1121 together with the second finger-pressure rod 1130.

A finger-pressure tip 1133 formed of an elastic material such as rubber or the like is detachably coupled to the free end portion of the second finger-pressure rod 1130. To do so, an insertion portion 1134 is formed at the free end portion thereof and, further, an engaging projection 1134a formed at an outer peripheral surface of the insertion portion 1134 is engaged with an engaging groove (not shown) formed at an inner peripheral surface of the finger-pressure tip 1133. Moreover, the finger-pressure tip 1133 is provided with the finger-pressure protrusion 1133a having various shapes depending on body parts to be massaged or levels of a finger-pressure treatment for an effective finger-pressure treatment, wherein the finger-pressure tip 1133 can be changed if necessary.

A vibration motor 1230 is preferably installed at the free end portion of the second finger-pressure rod 1130, i.e., inside the insertion portion 1134 so as to improve a finger-pressure treatment effect. In order to install the vibration motor 1230, the insertion portion 1134 has therein a mounting space (not shown) for installing the vibration motor 1230, and the mounting space is sealed by a lid 1136. In addition, a power supply line (not illustrated) for supplying a power to the vibration motor 1230 can be installed while penetrating the interior of the second finger-pressure rod 1130. Or, it is also possible to insert a power supply line into a cable insertion groove 1138 formed along a length direction of the second finger-pressure rod 1130 and then perform a molding process on the cable insertion groove 1138.

The motor 1140 provides a rotational force for rotating the second finger-pressure rod 1130 in order to press a body part positioned between the free end portions of the first and the second finger-pressure rod 1120 and 1130. In this case, the motor 1140 is installed at the casing 1110, perpendicular to the rotation axle 1116 coupled to the second finger-pressure rod 1130. Accordingly, when the motor 140 is positioned by considering the rotation direction of the first and the second finger-pressure rod 1120 and 1130, a size of the casing 1110 can be minimized. Especially, by forming the handle grip 1117 at a portion where the motor 1140 is positioned along the axial direction of the motor 1140, the casing 1110 can be designed compactly.

As depicted in FIGS. 27 and 28, the worm gear assembly 1190 is provided with a worm 1193 for transmitting the rotational force of the motor 140 to the second finger-pressure rod 1130 and a worm wheel 1194. The worm 1193 is fixedly inserted into the rotator of the motor 1140, and the worm wheel 1194 is rotatably installed in the housing 1191 to thereby rotate the second finger-pressure rod 1130 while being gear-coupled with the worm 1193.

The worm gear assembly 1190 includes one or more, e.g., three in this embodiment, reduction gears 1195, 1196 and 1197 for reducing a rotation speed of the worm wheel 1194 and then transmitting it to the second finger-pressure rod 1130, the reduction gears 1195, 1196 and 1197 being installed in the housing 1191.

When the rotational force of the motor 1140 is stably transmitted to the second finger-pressure rod 1130 by the worm 1193 and the worm wheel 1194 and, further, the free end portions of the first and the second finger-pressure rod 1120 and 1130 press a body part to a certain extent, a load exceeding a preset level is generated. Such generated load is dispersed by the worm 1193 and the worm wheel 1195 for switching the rotational force at a right angle. Accordingly, in comparison with other power transmission gears, a wear rate of the gears 1195 to 1197 can be decreased and, at the same time, a durability can be improved by minimizing the damage to the motor 140. Further, a pressing force of the second finger-pressure rod 1130 can be increased by the reduction gears 1195, 1196 and 1197.

As illustrated in FIGS. 24 to 26, one end of the elastic member 1150, i.e., a coil spring, is supported by a fixing flange 1191a protrudingly formed in a vertical direction at one side of the housing 1191 of the worm gear assembly 1190 so that the first finger-pressure rod 1120 can elastically support a body part during a finger-pressure treatment. In such state, the other end of the elastic member 1150 is fixed to the pressing member 1122 of the first finger-pressure rod 1120. The elastic force provided to the first finger-pressure rod 1120 is controlled by the finger-pressure level adjusting device 1180.

The finger-pressure level adjusting device 1180 is consituted by an adjusting bolt 1181 and a supporting washer 1182. The supporting washer 1182 is in contact with the end portion of the elastic member 1150. The adjusting bolt 1181 is screwed into the fixing flange 1911a formed at the housing 1191 of the worm gear assembly 1190 while being fixed to one side of the supporting washer 1182, thereby moving the supporting washer 1182 according to the rotation direction. Thus, a length of the elastic member 1150 is adjusted and, accordingly, the elastic force is controlled. The adjusting bolt 1181 is exposed through a through hole (not shown) formed at one side of the casing 1110 and, further, a “+” or “−” shaped groove (not shown) is formed at an end of the adjusting bolt 1181. Thus, the adjusting bolt 1181 can be easily turned by using a driver or the like.

As illustrated in FIGS. 24 to 26, when the free end portion of the first finger-pressure rod 1120 pushed by a body part pressed by an inward rotation of the free end portion of the second finger-pressure rod 1130, which is caused by an operation of the motor 340, outwardly rotates while positioning the body part for a finger-pressure treatment between the free end portions of the first and the second finger-pressure rod 1120 and 1130, the first detection sensor 1160 is pressed by a pressurizing surface 1121b formed at one side of a rotating block 1121 of the first finger-pressure rod 1120 and then outputs the detection signal to the controller 1170. Further, the first detection sensor 1160 is fixed to the housing 1191 of the worm gear assembly 1190 by screws or the like.

By providing the second detection sensor 1280, the controller 1170 can easily control the motor 1140 to position the body part between the free end portions of the first and the second finger-pressure rod 1120 and 1130 for a finger-pressure treatment by the outward rotation of the free end portion of the second finger-pressure rod 1130.

As depicted in FIGS. 21 to 23, the second detection sensor 1280 is installed at an opposite side of the first detection sensor 1160 in the housing 1191 of the worm gear assembly 1190. Further, when a body part requiring a finger-pressure treatment is positioned between the free end portions of the first and the second finger-pressure rod 1120 and 1130 by the outward rotation of the free end portion of the second finger-pressure rod 1130, the second detection sensor 1280 is pressed by a pressurizing protrusion 1131b protruded at one side of the coupling block 1131 of the second finger-pressure rod 1130 and then outputs the detection signal to the controller 1170.

The first and the second detection sensor 1160 and 1280 have connection elements 1161 and 1281 pressed by the pressurizing surface 1121b and the pressurizing protrusion 1131b provided at the end portions of the first and second rotating finger-pressure rod 1120 and 1130, the connection elements 1161 and 1281 having an elastic force for a restoration. Further, the first and the second detection sensor 1160 and 1280, i.e., switches being turned on/off depending on whether or not the connection elements 1161 and 1281 are pressed, have rotatable rollers 1162 and 1282 at the end portions of the connection elements 1161 and 1281 for an efficient contact with the pressurizing surface 1121b and the pressurizing protrusion 1131b of the first and the second finger-pressure rod 1120 and 1130.

The controller 1170 controls the motor 1140 by receiving the detection signals of the first and the second detection sensor 1160 and 1280, thereby increasing or reducing a force applied to a body part under a finger-pressure treatment performed by the first and the second finger-pressure rod 1120 and 1130.

A pressure level adjusting switch 1251 (shown in FIG. 20) for varying a rotation speed of the motor 1140 by an operation and a power switch 1252 are provided at an operation panel 1253 (shown in FIG. 19) fixed on one side of the casing 1110. Further, an initial operation switch 1254, which is a type of a touch switch operated by a user's contact, is provided at the handle grip 1117. While the initial operation switch 1254 is turned on, the controller 1170 controls the motor 1140 in such a manner that the free end portions of the first and the second finger-pressure rod 1120 and 1130 can be opened

Additionally, there can be further provided a light emitting device 1270 for emitting light according to control signals of the controller 1170 when a finger-pressure treatment is performed by driving the motor 1140 with the controller 1170. The light emitting device 1270, which is constituted by a pair of lamps provided at one side of the casing 1110 in this embodiment, is turned on and off by turns during the finger-pressure treatment.

Hereinafter, an operation of the finger-pressure apparatus 1100, which has the aforementioned configuration, in accordance with the third embodiment of the present invention will be described.

First, if the power switch 1252 is turned on and, further, the initial operation switch 1254 is turned on by the contact, the controller 1170 drives the motor 1140. Accordingly, as illustrated in FIGS. 21 and 24, the free end portion of the second finger-pressure rod 1130 is outwardly rotated until the pressurizing protrusion 1131b of the second finger-pressure rod 1130 presses the connection element 1281 of the second detection sensor 1280, so that the second detection sensor 1280 outputs the detection signal. As a result, the free end portions of the first and the second finger-pressure rod 1120 and 1130 are opened so that a body part requiring a finger-pressure treatment can be positioned therebetween.

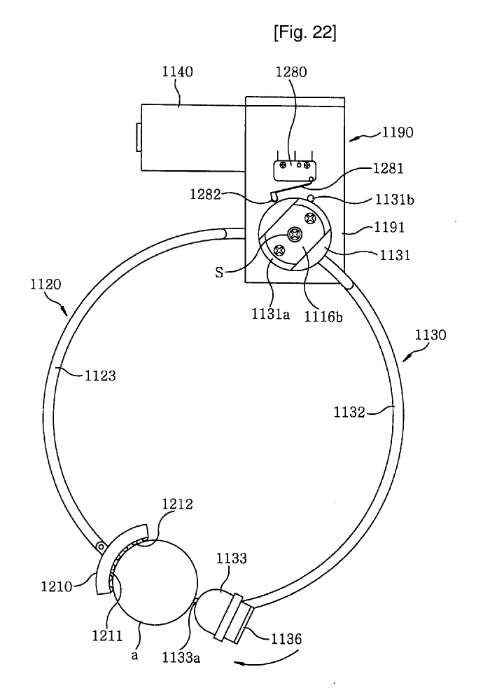

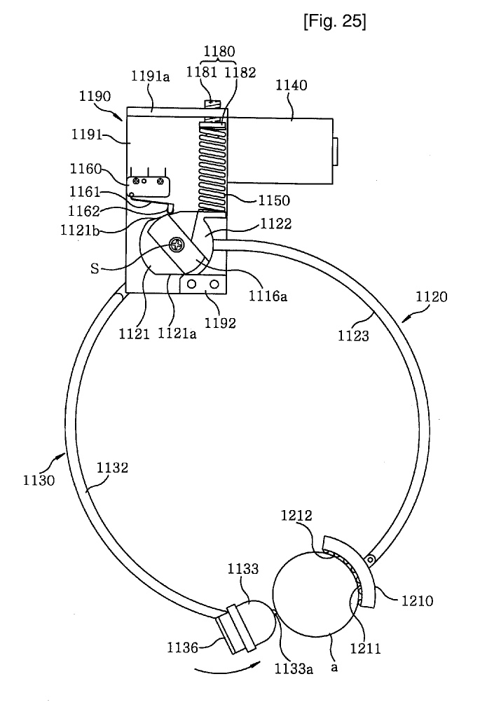

If the body part (a) requiring the finger-pressure treatment is positioned between the end portions of the first and the second finger-pressure rod 1120 and 1130, when the initial operation switch 1254 is turned off by the noncontact or after a preset period of time has elapsed, the controller 1170 drives the motor 1140. Accordingly, as shown in FIGS. 22 and 25, the second finger-pressure rod 1130 rotates and, thus, the body part (a) is pressed by the finger-pressure protrusions 1212 and 1133a of the finger-pressure plate 1210 and the finger-pressure tip 1133 provided at the free end portions of the first and the second finger-pressure rod 1120 and 1130.

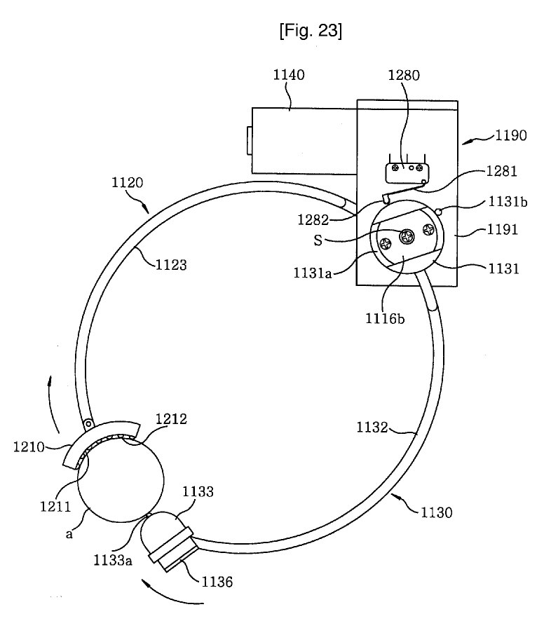

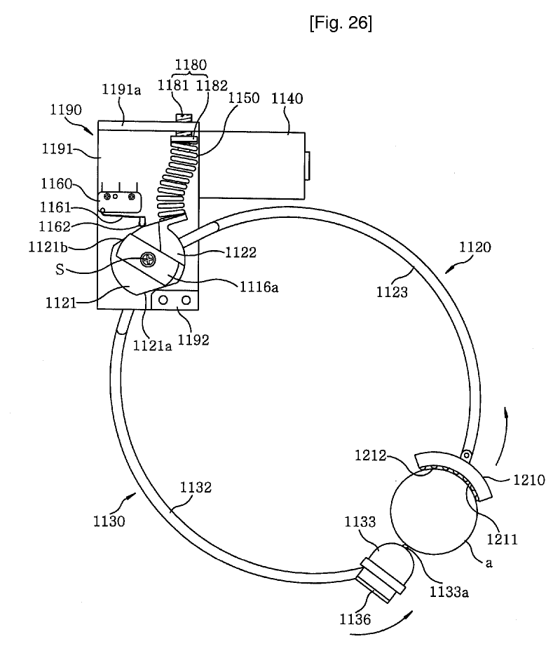

Furthermore, as illustrated in FIGS. 23 and 26, if the free end portion of the second finger-pressure rod 1130 constantly presses the body part (a), the end portion of the first finger-pressure rod 1120 is pushed by the press of the body part (a) to be outwardly rotated. Accordingly, when the pressurizing surface 1121b of the first finger-pressure rod 1120 presses the connection member 1161 of the first detection sensor 1160, the first detection sensor 1160 outputs the detection signal to the controller 1170. If the detection signal of the first detection sensor 1160 is transmitted to the controller 1170, the controller 1170 recognizes that the first and the second finger-pressure rod 1120 and 1130 performs a finger-pressure treatment on the body part a. Then, the controller 1170 switches the rotation direction of the motor 1140, thereby separating the free end portion of the second finger-pressure rod 1130 from the body part. If such operations are repeated by the controller 1170, the finger-pressure treatment is repeatedly performed on the body part (a).

Further, when the second finger-pressure rod 1130 is separated from the first finger-pressure rod 1120 due to its outward rotation, the second detection sensor 1280 is pressurized by the pressurizing protrusion 1131 and then outputs the detection signal. Accordingly, the controller 1170 can recognize that the free end portion of the second finger-pressure rod 1139 is separated from the body part (a) and, then switches the rotation direction of the motor 1140 so that the free end portion of the second finger-pressure rod 1130 can press the body part (a) again according to the detection signal outputted from the second detection sensor 1280.

In order to control a level of the finger-pressure treatment performed on the body part (a) by the first and the second finger-pressure rod 1120 and 1130, a length of the elastic member 1150 can be controlled by rotating the adjusting bolt 1181 of the finger-pressure controller 1180. Further, the pressing force of the second finger-pressure rod 1130 is controlled according to a level of a power applied to the motor 1140 by the operation of the pressure level adjusting switch 1251.

The finger-pressure tip 1133 can be changed depending on body parts to be massaged and purposes of the finger-pressure treatment. Further, a vibration is applied to the body part (a) under the finger-pressure treatment with the vibration motor 1230, thereby enabling an effective finger-pressure treatment.

While the invention has been shown and described with respect to the preferred embodiment, it will be understood by those skilled in the art that various changes and modifications may be made without departing from the spirit and scope of the invention as defined in the following claims.

1. An apparatus for performing a finger-pressure treatment on a body part, the apparatus comprising:
a first finger-pressure rod to be in contact with one surface of the body part;
a second finger-pressure rod for applying press on an opposite surface of the body part substantially opposite to said one surface;
a driving unit for generating a rotational force;
a rotation axle connected to an end portion of the second finger-pressure rod, for transmitting the rotational force of the driving unit to the second finger-pressure rod;
an elastic member which is connected to an end portion of the first finger-pressure rod and applies an elastic force to the first finger-pressure rod in such manner that the first finger-pressure rod is rotated in a first direction opposite to a second direction in which the press of the second finger-pressure rod applied on the body part; and
a mounting plate on which the rotation axle is rotatably mounted and the elastic member is mounted,
wherein the rotation axle is rotatably inserted into the end portion of the first finger-pressure rod, so that the rotational force of the driving unit is prevented from being transmitted to the first finger-pressure rod.

2. The apparatus of claim 1, further comprising:
a detection unit mounted on the mounting plate, for generating a signal when the first finger-pressure rod rotates at more than a preset angle in the second direction; and
a controller for controlling the driving unit by receiving the signal of the detection unit,
wherein if the controller receives the signal of the detection unit, the controller controls the driving unit to rotate the second finger-pressure rod in the first direction.

3. The apparatus of claim 2, further comprising:
a stopper mounted on the mounting plate, for preventing the first finger-pressure rod from rotating at more than a preset angle in the first direction,
wherein the elastic member elastically biases the end portion of the first finger-pressure into engagement with the stopper.

4. The apparatus of claim 3, further comprising:
an adjusting unit for controlling the elastic force of the elastic member constituted by a spring by adjusting a length of the spring,
wherein a level of the press applied by the second finger-pressure rod on the body part is controlled by using the adjusting unit.

5. The apparatus of claim 3, further comprising:
an opening detection unit mounted on the mounting plate, for generating, when the second finger-pressure rod rotates at more than a preset angle in the first direction, a signal and then transmitting the signal to the controller,
wherein in case the controller receives the signal of the opening detection unit, the controller controls the driving unit to stop a rotation of the second finger-pressure rod.

6. The apparatus of claim 5, further comprising:
a switch electrically connected to the controller,
wherein in case a user turns on the switch, the controller controls the driving unit to rotate the second finger-pressure rod in the first direction.

7. The apparatus of claim 3, further comprising:
a reduction unit for transmitting the rotational force of the driving unit to the rotation axle,
wherein the reduction unit consituted by a plurality of gears increases the rotational force of the driving unit and reduces a rotation speed thereof.

8. The apparatus of claim 7, wherein the reduction unit has a worm gear assembly and, further, a worm of the worm gear assembly is attached to a rotator of the driving unit, the rotator of the motor being installed in substantially parallel to a plane on which the first and the second finger-pressure rod rotate.

9. The apparatus of claim 3, wherein the first finger-pressure rod has a finger-pressure plate to be in contact with the body part, the finger-pressure plate rotatably connected to a free end portion of the first finger-pressure rod.

10. The apparatus of claim 3, wherein the second finger-pressure rod has a finger-pressure tip attached to a free end portion of the second finger-pressure rod, the finger-pressure tip accommodating a vibration unit for generating vibration therein.
